(19) United States
(12) Patent Application Publication
(10) Pub. No.: US 2014/0084121 A1
(43) Pub. Date: Mar. 27, 2014

(54) CLAMPING MECHANISM WITH EASY ASSEMBLY AND ANTENNA DEVICE THEREWITH

(71) Applicant: WISTRON NEWEB CORPORATION, Hsinchu (TW)

(72) Inventors: Ming-Chan Lee, Hsinchu (TW); Lan-Chun Yang, Hsinchu (TW); Hung-Yuan Lin, Hsinchu (TW); Yu-Fu Ku, Hsinchu (TW)

(73) Assignee: WISTRON NEWEB CORPORATION, Hsinchu (TW)

(21) Appl. No.: 13/738,956

(22) Filed: Jan. 10, 2013

(30) Foreign Application Priority Data
Sep. 27, 2012 (TW) 101218703

(51) Int. Cl. F16M 13/02

(52) U.S. Cl. CPC F16M 13/022
USPC 248/230.1; 248/295.11

(57) ABSTRACT

A clamping mechanism includes a clamping member, a first fixing member, a second fixing member, a shaft, a first adjusting member, a second adjusting member and a handle. The clamping member encloses a supporting tube. The first fixing member and the second fixing member are connected to the clamping member, respectively. The shaft is disposed through the first fixing member and the second fixing member. The first adjusting member, connected to the shaft, abuts against the first fixing member. The second adjusting member, connected to the shaft, cooperates with the first adjusting member for driving the second fixing member to move relative to the first fixing member along the shaft. The handle, pivoted to the second fixing member, abuts against the second fixing member for pressing the second fixing member to approach the first fixing member, so as to force the clamping member to clamp the supporting tube.

### BACKGROUND OF THE INVENTION

1. Field of the Invention

The present invention relates to a clamping mechanism and antenna device therewith, and more particularly, to a clamping mechanism with easy assembly and antenna device therewith.

2. Description of the Prior Art

A conventional satellite antenna device includes a holder, a supporting tube and a clamping mechanism. The supporting tube is used for supporting the holder, and the holder is used for holding a satellite antenna disk, such that the satellite antenna disk is capable of receiving satellite signals. The clamping mechanism is used for fixing the holder and the supporting tube, such that the supporting tube can support the holder stably. Conventionally, the clamping mechanism forces a clamping body thereof to clamp the supporting tube in a screwed manner. The aforesaid design requires additional tools, such as a screw driver, resulting in complex assembly process, and thus it is not convenient for a user to install and use.

### SUMMARY OF THE INVENTION

The present invention provides a clamping mechanism with easy assembly and antenna device therewith for solving above drawbacks.

According to an embodiment of the present invention, a clamping mechanism includes a clamping member, a connecting portion, a first fixing member, a second fixing member, a shaft, a first adjusting member, a second adjusting member and a handle. The clamping member is for enclosing a supporting tube, and the connecting portion extends from the clamping member for being connected a holder. The first fixing member is connected to an edge of the clamping member, and the second fixing member is connected to another edge of the clamping member. The shaft is disposed through the first fixing member and the second fixing member. The first adjusting member is connected to an end of the shaft and abuts against the first fixing member. The second adjusting member is connected to the other end of the shaft, and the second adjusting member cooperates with the first adjusting member for driving the second fixing member to move relative to the first fixing member along the shaft, so as to adjust a gap between the first fixing member and the second fixing member. The handle is pivoted to the second fixing member and abuts against the second fixing member for pressing the second fixing member to approach the first fixing member, so as to force the clamping member to clamp the supporting tube.

According to another embodiment of the present invention, the handle includes a pivotal portion, a pressing cam and a handle portion. The pivotal portion is eccentrically pivoted to the second adjusting member. The pressing cam protrudes from the pivotal portion. The handle portion is connected to the pivotal portion for rotating the pivotal portion to drive the pressing cam to press the second fixing member.

According to another embodiment of the present invention, a pivotal hole is formed on the pivotal portion for being pivoted to the second adjusting member. The pivotal portion includes a slot structure connected to a surface of the pressing cam and the pivotal hole, and the other end of the shaft is connected to the second adjusting member via the slot structure.

According to another embodiment of the present invention, the shaft includes a thread portion, and the first adjusting member and the second adjusting member are respectively screwed to the end of the shaft and the other end of the shaft.

According to another embodiment of the present invention, the shaft and the first adjusting member are integrally formed.

According to another embodiment of the present invention, the shaft and the second adjusting member are integrally formed.

According to another embodiment of the present invention, the clamping member is a substantially rectangular clamping structure.

According to another embodiment of the present invention, the clamping member includes a stopping structure for stopping an end of the supporting tube.

According to another embodiment of the present invention, the clamping member, the connecting portion, the first fixing member and the second fixing member are integrally formed.

According to another embodiment of the present invention, the connecting portion is riveted to the holder.

According to another embodiment of the present invention, the supporting tube is an antennal receiving holder.

According to another embodiment of the present invention, an antenna device includes a holder, a supporting tube and a clamping mechanism. The supporting tube is for supporting the holder, and the clamping mechanism is for fixing the holder and the supporting tube. The clamping mechanism includes a clamping member, a connecting portion, a first fixing member, a second fixing member, a shaft, a first adjusting member, a second adjusting member and a handle. The clamping member is for enclosing a supporting tube, and the connecting portion extends from the clamping member for being connected a holder. The first fixing member is connected to an edge of the clamping member, and the second fixing member is connected to another edge of the clamping member. The shaft is disposed through the first fixing member and the second fixing member. The first adjusting member is connected to an end of the shaft and abuts against the first fixing member. The second adjusting member is connected to the other end of the shaft, and the second adjusting member cooperates with the first adjusting member for driving the second fixing member to move relative to the first fixing member along the shaft, so as to adjust a gap between the first fixing member and the second fixing member. The handle is pivoted to the second fixing member and abuts against the second fixing member for pressing the second fixing member to approach the first fixing member, so as to force the clamping member to clamp the supporting tube.

In summary, the present invention utilizes the second adjusting member to cooperate with the first adjusting member for driving the second fixing member to move relative to the first fixing member along the shaft, so as to adjust the gap between the first fixing member and the second fixing member. Accordingly, the first adjusting member and the second adjusting member can make the clamping member to apply the supporting tube with the clamping force in advance. When the supporting tube is desired to be fixed on the clamping member, the handle is rotated to press the second fixing member to approach the first fixing member. In the meantime, the clamping member is capable of clamping the supporting tube for preventing the supporting tube from being detached from the clamping member. When the supporting tube is desired to be detached from the clamping member, the handle is rotated to release the second fixing member and the first fixing member. In the meantime, the clamping member is capable of releasing the supporting tube for detaching the supporting tube from the clamping member. As mentioned above, the clamping mechanism of the present invention utilizes the handle to force the clamping member to clamp the supporting tube or to release the clamping member and the supporting tube in a rotable manner. Accordingly, the present invention does not requires screws and tools, such as a screw driver, for screwing the screws, resulting in easy assembly process, and thus it is convenient for a user to install and use.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an antenna device according to a first embodiment of the present invention.

FIG. 2 is an exploded diagram of the antenna device according to the first embodiment of the present invention.

FIG. 3 is a partly exploded diagram of the antenna device according to the first embodiment of the present invention.

FIG. 4 is a diagram of a clamping member and a connecting portion according to the first embodiment of the present invention.

FIG. 5 is a diagram of the clamping member and the connecting portion in another view according to the first embodiment of the present invention.

FIG. 6 is a diagram of a handle according to the first embodiment of the present invention.

FIG. 7 is a diagram of a first adjusting member according to the first embodiment of the present invention.

FIG. 8 is a diagram of a second adjusting member according to the first embodiment of the present invention.

FIG. 9 is a diagram of the clamping mechanism in a released status according to the first embodiment of the present invention.

FIG. 10 is a diagram of the clamping mechanism in a forcing status according to the first embodiment of the present invention.

FIG. 11 is a sectional diagram of the clamping mechanism in the forcing status according to the first embodiment of the present invention.

FIG. 12 is an exploded diagram of a clamping mechanism according to a second embodiment of the present invention.

FIG. 13 is an exploded diagram of a clamping mechanism according to a third embodiment of the present invention.

### DETAILED DESCRIPTION

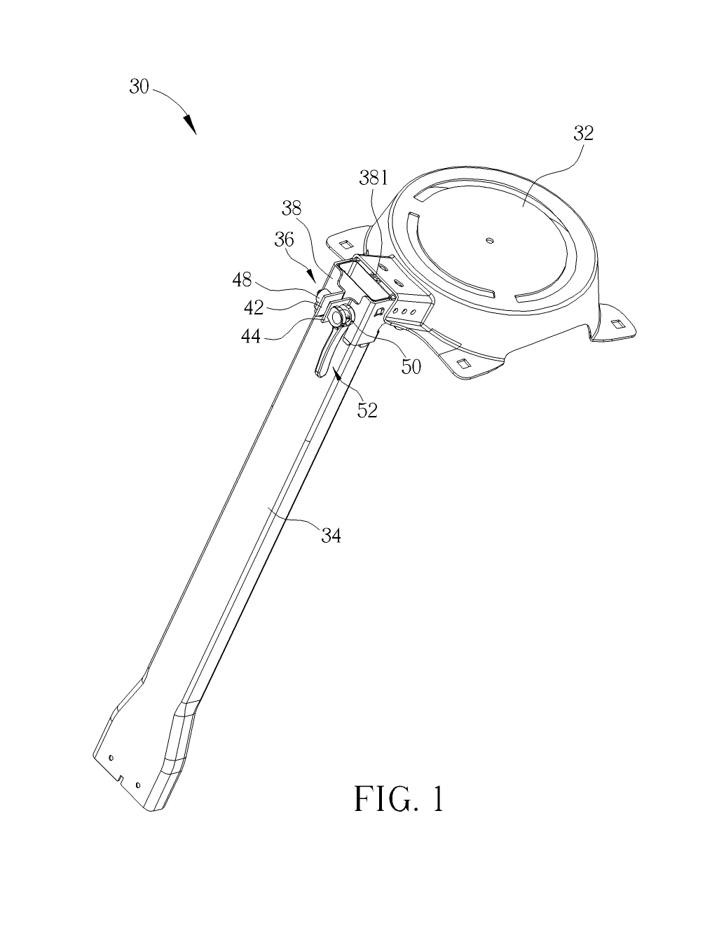

Please refer to FIG. 1. FIG. 1 is a schematic diagram of an antenna device 30 according to a first embodiment of the present invention. As shown in FIG. 1, the antenna device 30 includes a holder 32, a supporting tube 34 and a clamping mechanism 36. The supporting tube 34 is used for supporting the holder 32. In this embodiment, the supporting tube 34 is a satellite antenna holder, and the holder 32 is used for holding a satellite antenna disk, not shown in figures. Furthermore, the clamping mechanism 36 is used for fixing the holder 32 and the supporting tube 34, such that the satellite antenna disk is disposed on the supporting tube 34 stably by utilizing the holder 32. In such a manner, the satellite antenna disk can be disposed on a fixing plane, such as a ground, for receiving satellite signals. It should be noticed that implementation of the clamping mechanism 36 is not limited to those mentioned in this embodiment. For example, the clamping mechanism 36 can be used for clamping a supporting tube and a light body adapted to a traffic light device. In other words, implementations for connecting a tube structure and a disk structure are within the scope of the present invention.

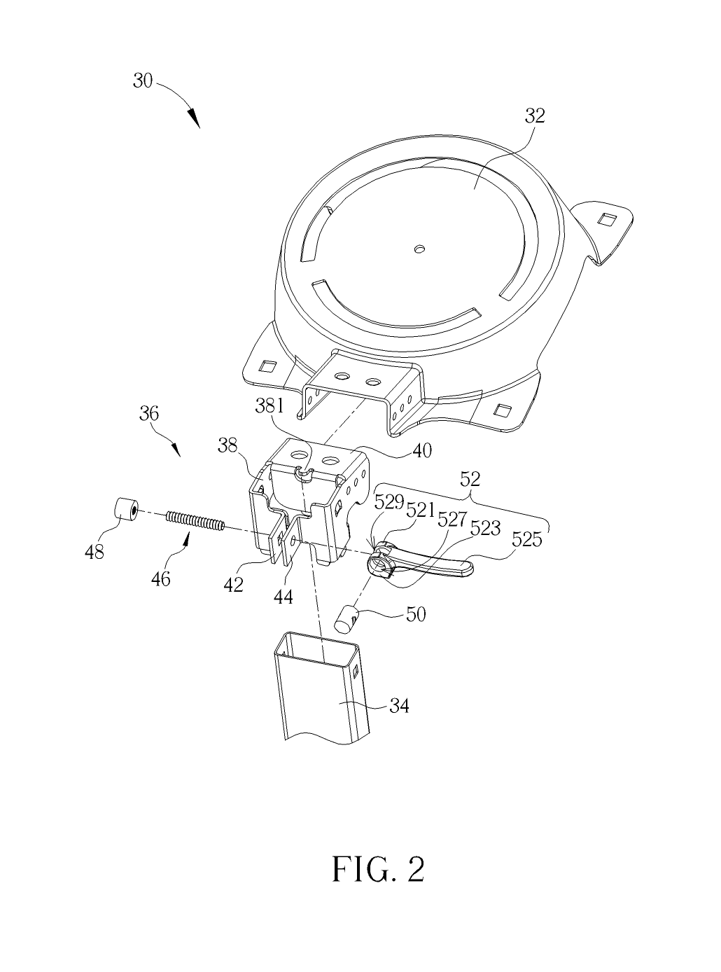

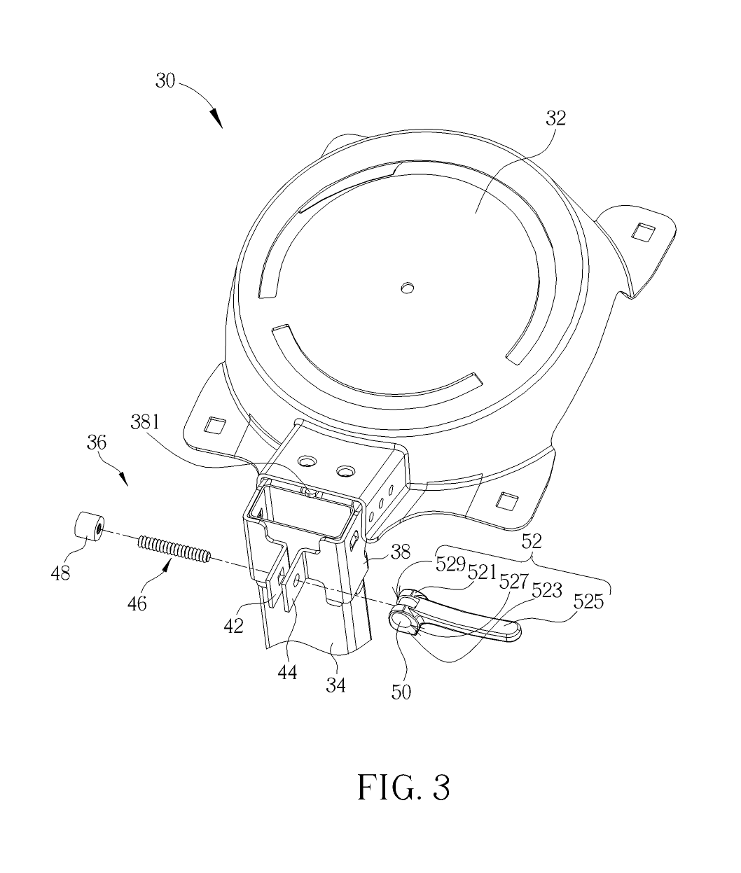

Please refer to FIG. 2 and FIG. 3. FIG. 2 is an exploded diagram of the antenna device 30 according to the first embodiment of the present invention. FIG. 3 is a partly exploded diagram of the antenna device 30 according to the first embodiment of the present invention. As shown in FIG. 2 and FIG. 3, the clamping mechanism 36 includes a clamping member 38 for enclosing the supporting tube 34. In this embodiment, the clamping member 38 is a substantially rectangular clamping structure, and the supporting tube 34 is a substantially rectangular tube corresponding to the rectangular clamping structure. Structures of the clamping member 38 of the clamping mechanism 36 are not limited to those mentioned in this embodiment. For example, the clamping member 38 can be a substantially circular clamping structure as well, and the supporting tube 34 can be a substantially circular tube corresponding to the circular clamping structure. As for which one of the aforesaid designs is adopted, it depends on practical demands.

In addition, the clamping mechanism 36 further includes a connecting portion 40 extending from the clamping member 38 for being connected a holder 32. In this embodiment, the connecting portion 40 of the clamping mechanism 36 is, but not limited to, riveted to the holder 32. For example, the connecting portion 40 of the clamping mechanism 36 can be screwed or welded to the holder 32 as well. As for which one of the aforesaid designs is adopted, it depends on practical demands. Furthermore, an orientation of the connecting portion 40 is substantially perpendicular to an orientation of the clamping member 38. Accordingly, when the holder 32 and the supporting tube 34 are respectively combined with the clamping member 38 by the connecting portion 40, an orientation of the holder 32 is substantially perpendicular to an orientation of the supporting tube 34. Designs of orientation of the connecting portion 40 and the clamping member 38 are not limited to those mentioned in this embodiment, and it depends on practical demands. In this embodiment, the clamping member 38 and the connecting portion 40 are integrally formed in a stamping manner.

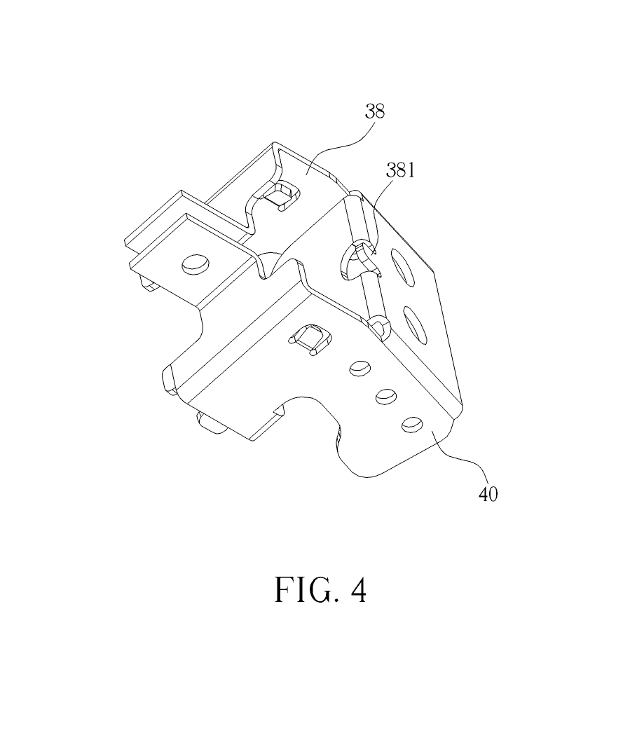

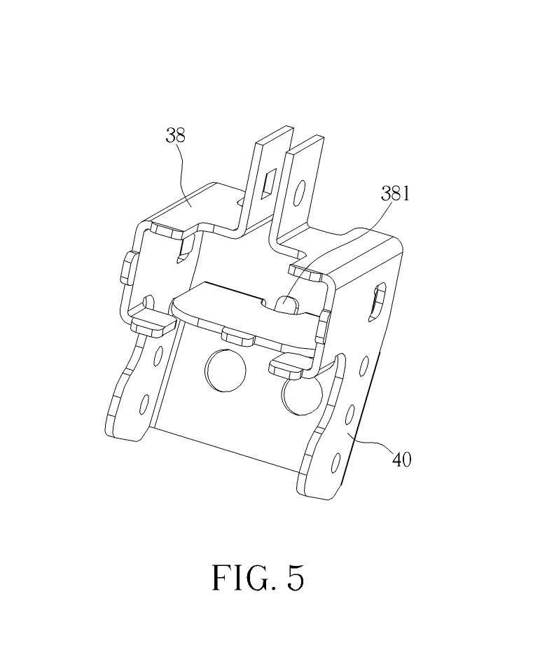

Please refer to FIG. 2 to FIG. 5. FIG. 4 is a diagram of the clamping member 38 and the connecting portion 40 according to the first embodiment of the present invention. FIG. 5 is a diagram of the clamping member 38 and the connecting portion 40 in another view according to the first embodiment of the present invention. As shown in FIG. 2 to FIG. 5, the clamping member 38 includes a stopping structure 381. When the supporting tube 34 and the clamping member 38 of the clamping mechanism 36 are assembled, the supporting tube 34 is inserted into a space enclosed by the clamping member 38, and then the supporting tube 34 is pushed to move along the clamping member 38, until an end of the supporting tube 34 abuts against the stopping structure 381 of the clamping member 38. In other words, the stopping structure 381 of the clamping member 38 is used for stopping the end of the supporting tube 34, so as to position in advance during assembly.

In this embodiment, the clamping member 38 of the present invention includes one stopping structure 381 which is disposed in a position corresponding to a central line of the supporting tube 34. An amount and disposal positions are not limited to those mentioned in this embodiment. For example, the clamping member 38 of the present invention can include two stopping structures 381 which are disposed in positions corresponding to both sides of the supporting tube 34. In other words, structures including at least one stopping structure 381 are within the scope of the present invention.

As shown in FIG. 1 to FIG. 5, the clamping mechanism 36 further includes a first fixing member 42 and a second fixing member 44. The first fixing member 42 is connected to an edge of the clamping member 38, and the second fixing member 44 is connected to another edge of the clamping member 38. In this embodiment, the clamping member 38, the connecting portion 40, the first fixing member 42 and the second fixing member 44 are, but not limited to, integrally formed in a stamping manner. In other words, the clamping member 38, the connecting portion 40, the first fixing member 42 and the second fixing member 44 can be respectively a separate part as well, and the clamping member 38, the connecting portion 40, the first fixing member 42 and the second fixing member 44 can be welded as an integral. As for which one of the aforesaid designs is adopted, it depends on practical demands.

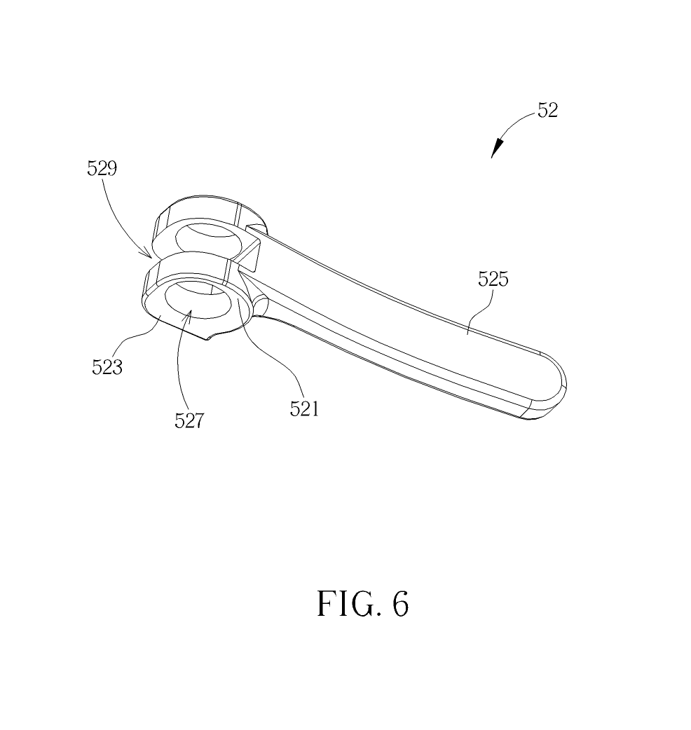

In addition, the clamping mechanism 36 further includes a shaft 46, a first adjusting member 48, a second adjusting member 50 and a handle 52. The shaft 46 is disposed through the first fixing member 42 and the second fixing member 44. The first adjusting member 48 is connected to an end of the shaft 46 and abuts against the first fixing member 42. The second adjusting member 50 is connected to the other end of the shaft 46, i.e. the first adjusting member 48 and the second adjusting member 50 are disposed on different two sides of the first fixing member 42 and the second fixing member 44. The handle 52 is pivoted to the second fixing member 50 and abuts against the second fixing member 44. Please refer to FIG. 6. FIG. 6 is a diagram of the handle 52 according to the first embodiment of the present invention. As shown in FIG. 6, the handle 52 includes a pivotal portion 521, a pressing cam 523 and a handle portion 525. The pressing cam 523 protrudes from the pivotal portion 521, and the handle portion 525 is connected to the pivotal portion 521.

As shown in FIG. 1 to FIG. 6, a pivotal hole 527 is formed on the pivotal portion 521 of the handle 52 and located eccentrically. The pivotal hole 527 is for being pivoted to the second adjusting member 50. Since the pivotal hole 527 is eccentrically formed on the pivotal portion 521, the pivotal portion 521 of the handle 52 is eccentrically pivoted to the second adjusting member 50. In addition, the pivotal portion 521 of the handle 52 includes a slot structure 529 connected to a surface of the pressing cam 523 and the pivotal hole 527. When the end of the shaft 46 is connected to the first adjusting member 48, the other end of the shaft 46 is capable of being connected to the second adjusting member 50 by passing through the first fixing member 42, the second fixing member 44 and the slot structure 529.

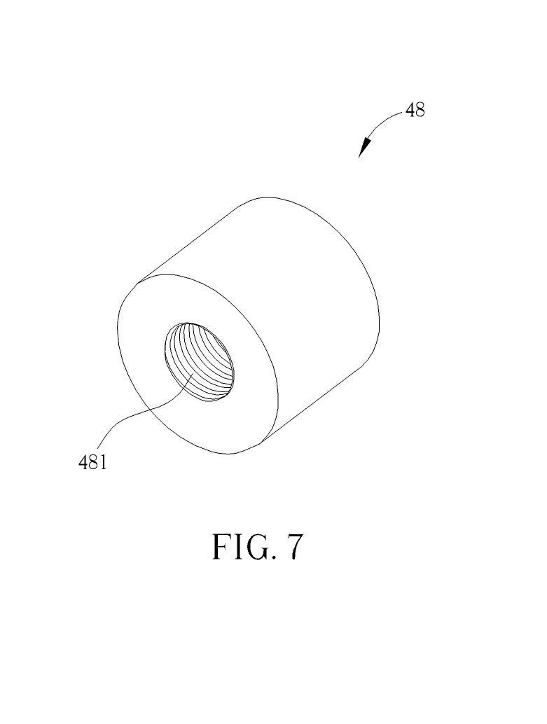

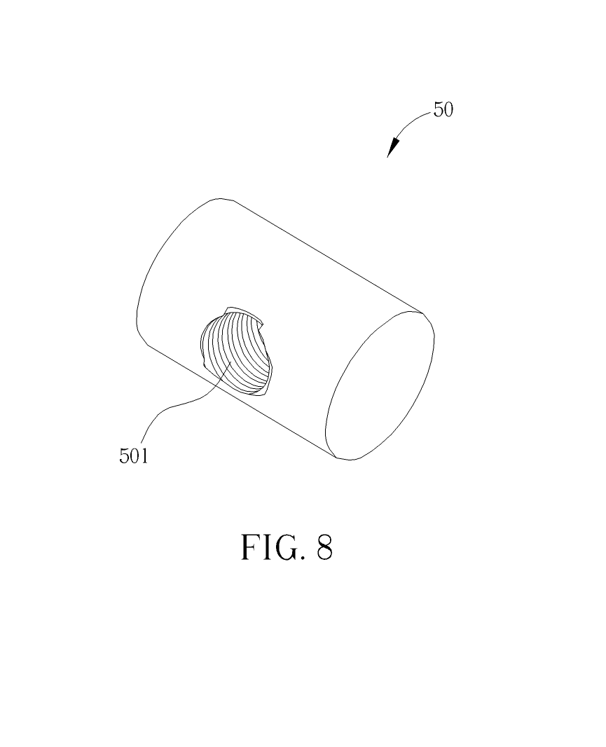

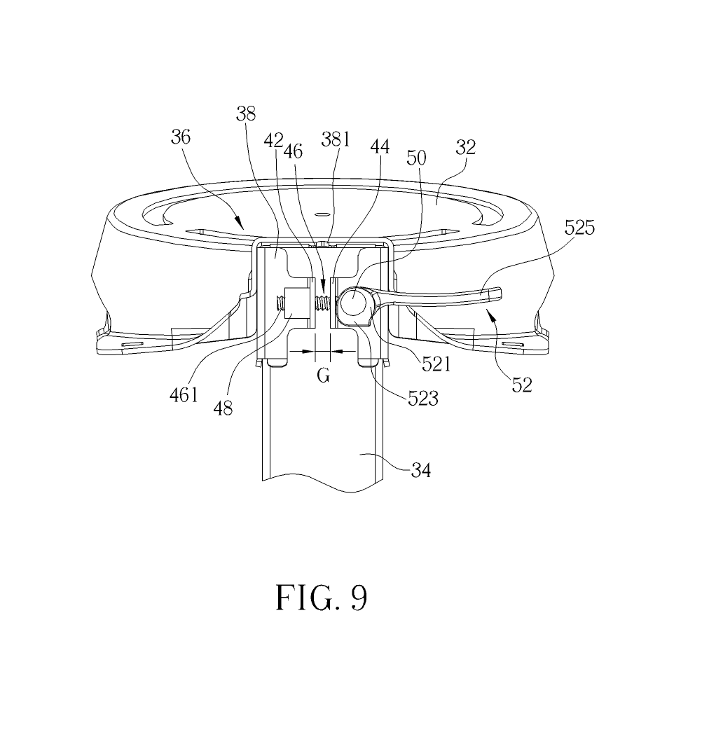

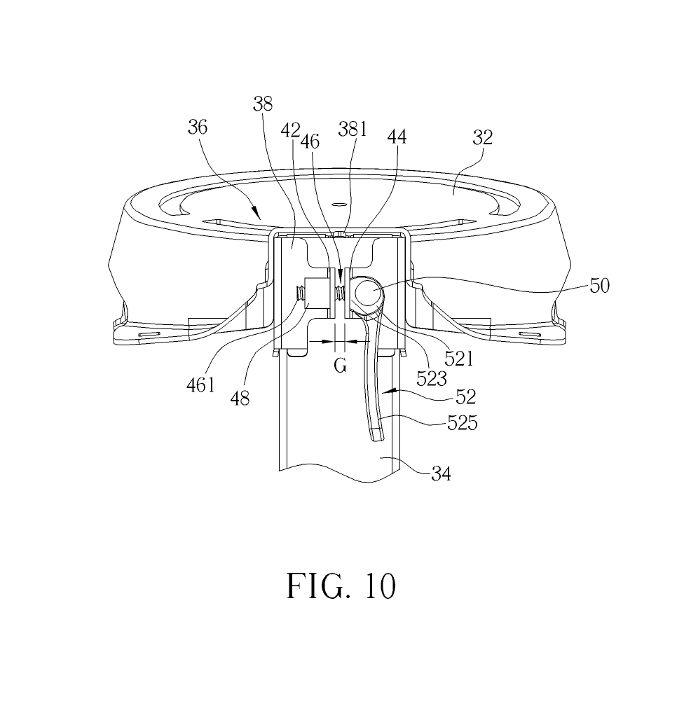

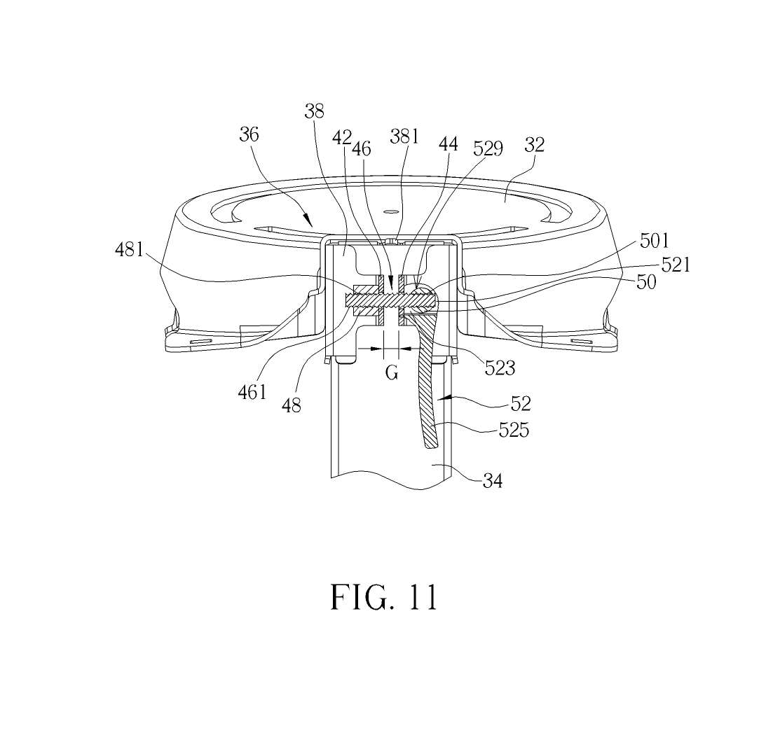

Please refer to FIG. 7 to FIG. 11. FIG. 7 is a diagram of the first adjusting member 48 according to the first embodiment of the present invention. FIG. 8 is a diagram of the second adjusting member 50 according to the first embodiment of the present invention. FIG. 9 is a diagram of the clamping mechanism 36 in a released status according to the first embodiment of the present invention. FIG. 10 is a diagram of the clamping mechanism 36 in a forcing status according to the first embodiment of the present invention. FIG. 11 is a sectional diagram of the clamping mechanism 36 in the forcing status according to the first embodiment of the present invention. As shown in FIG. 7 to FIG. 11, the first adjusting member 48 includes an internal thread structure 481, the second adjusting member 50 includes an internal thread structure 501, and the shaft 46 includes a thread portion 461. By cooperation of the internal thread structure 481 and the thread portion 461, the first adjusting member 48 can be screwed to the end of the shaft 46. By cooperation of the internal thread structure 501 and the thread portion 461, the second adjusting member 50 can be screwed to the other end of the shaft 46.

Furthermore, by cooperation of the internal thread structure 481, 501 and the thread portion 461, the first adjusting member 48 and the second adjusting member 50 can relatively move along the shaft 46 as being screwed. In such a manner, the second adjusting member 50 can cooperate with the first adjusting member 48 for driving the second fixing member 44 to move relative to the first fixing member 42 along the shaft 46, so as to adjust a gap G between the first fixing member 42 and the second fixing member 44. By adjustment of the aforesaid gap G, the first adjusting member 48 and the second adjusting member 50 can be used for making the clamping member 38 apply the supporting tube 34 with a clamping force in advance. In such a manner, the end of the supporting tube 34 can be inserted into the clamping member 38 to a released position shown in FIG. 9, or the end of the supporting tube 34 as being in the released position shown in FIG. 9 can be detached from the clamping member 38.

Then, the handle portion 525 of the handle 52 can be rotated from the released position shown in FIG. 9 to a forcing position shown in FIG. 10. In the meantime, the handle portion 525 rotates the pivotal portion 521 to drive the pressing cam 523 of the handle 52 to press the second fixing member 44. In other words, when the handle 52 is located in the forcing position shown in FIG. 10, the pressing cam 523 of the handle 52 can press the second fixing member 44 to make the clamping member 38 clamp the supporting tube 34. In summary, the handle 52 can be used for pressing the second fixing member 44 to approach the first fixing member 42, so as to force the clamping member 38 to clamp the supporting tube 34. In such a manner, the clamping member 38 is capable of fixing the supporting tube 34 for preventing the supporting tube 34 from detaching from the clamping member 38.

When the supporting tube 34 is desired to be detached from the clamping member 38, the handle portion 525 of the handle 52 is rotated from the forcing position shown in FIG. 10 to the released position shown in FIG. 9. In the meantime, the handle portion 525 rotates the pivotal portion 521, such that the pressing cam 523 of the handle 52 does not press the second fixing member 44, as shown in FIG. 9. In other words, when the handle 52 is located in the released position shown in FIG. 9, the pressing cam 523 of the handle 52 can not press the second fixing member 44, such that the supporting tube 34 is capable of being detached from the clamping member 38. In summary, the handle 52 can be further used for releasing the second fixing member 44 and the first fixing member 42, so as to release the clamping member 38 and the supporting tube 34. In such a manner, the supporting tube 34 is capable of being detached from the clamping member 38.

In this embodiment, the pressing cam 523 of the handle 52 is a platform structure. When the pressing cam 523 presses the second fixing member 44, the platform structure, i.e. the pressing cam 523, contacts the second fixing member 44 with a plane surface. Accordingly, the platform structure, i.e. the pressing cam 523, can stably press the second fixing member 44. Structures of the pressing cam 523 are not limited to those mentioned in this embodiment. For example, the pressing cam 523 of the handle 52 can be an arc-shaped protrusion as well. In other words, protruding structures for pressing the second fixing member 44 are within the scope of the present invention.

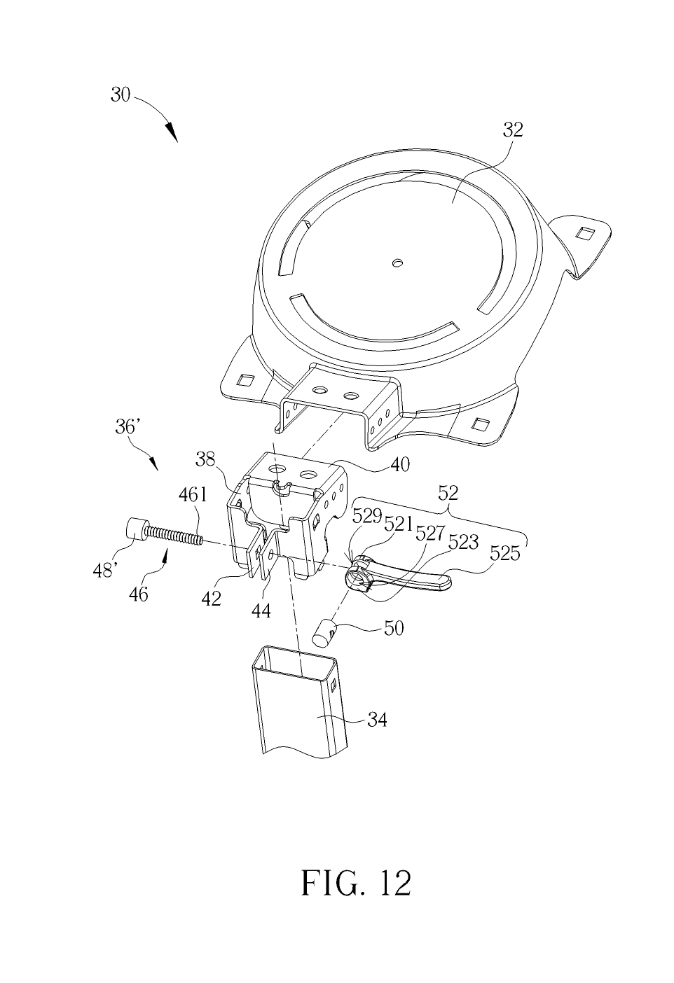

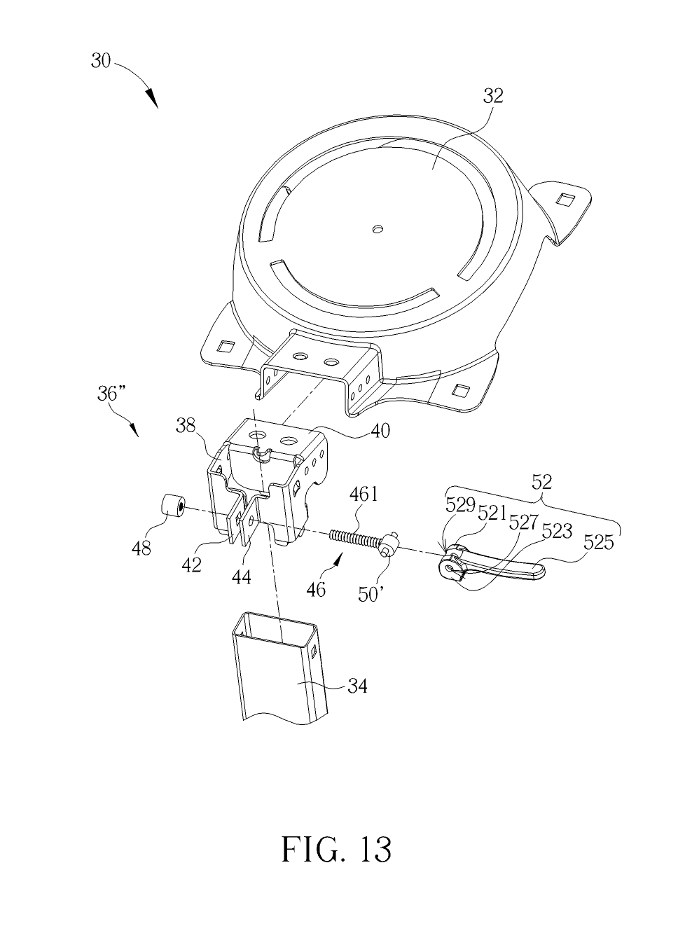

Please refer to FIG. 12. FIG. 12 is an exploded diagram of a clamping mechanism 36′ according to a second embodiment of the present invention. As shown in FIG. 12, the main difference between the clamping mechanism 36′ and the aforesaid clamping mechanism 36 is that the shaft 46 and a first adjusting member 48′ of the clamping mechanism 36′ are integrally formed. In practical application, the shaft 46 and the first adjusting member 48′ can be, but not limited to, a thread post and a screw head of a screw component, respectively. The first adjusting member 48′ can be a riveting structure of the shaft 46 as well. As for which one of the aforesaid designs is adopted, it depends on practical demands. Please refer to FIG. 13. FIG. 13 is an exploded diagram of a clamping mechanism 36″ according to a third embodiment of the present invention. As shown in FIG. 13, the main difference between the clamping mechanism 36″ and the aforesaid clamping mechanism 36 is that the shaft 46 and the second adjusting member 50′ of the clamping mechanism 36″ are integrally formed. Principles of the clamping mechanism 36″ are identical to those in the aforesaid embodiments, and detailed descriptions are omitted herein for simplicity.

Compared to the prior art, the present invention utilizes the second adjusting member to cooperate with the first adjusting member for driving the second fixing member to move relative to the first fixing member along the shaft, so as to adjust the gap between the first fixing member and the second fixing member. Accordingly, the first adjusting member and the second adjusting member can make the clamping member to apply the supporting tube with the clamping force in advance. When the supporting tube is desired to be fixed on the clamping member, the handle is rotated to press the second fixing member to approach the first fixing member. In the meantime, the clamping member is capable of clamping the supporting tube for preventing the supporting tube from being detached from the clamping member. When the supporting tube is desired to be detached from the clamping member, the handle is rotated to release the second fixing member and the first fixing member. In the meantime, the clamping member is capable of releasing the supporting tube for detaching the supporting tube from the clamping member. As mentioned above, the clamping mechanism of the present invention utilizes the handle to force the clamping member to clamp the supporting tube or to release the clamping member and the supporting tube in a rotable manner. Accordingly, the present invention does not requires screws and tools, such as a screw driver, for screwing the screws, resulting in easy assembly process, and thus it is convenient for a user to install and use.

Those skilled in the art will readily observe that numerous modifications and alterations of the device and method may be made while retaining the teachings of the invention. Accordingly, the above disclosure should be construed as limited only by the metes and bounds of the appended claims.

1. A clamping mechanism with easy assembly, comprising:
a clamping member for enclosing a supporting tube;
a connecting portion extending from the clamping member for being connected a holder;
a first fixing member connected to an edge of the clamping member;
a second fixing member connected to another edge of the clamping member;
a shaft disposed through the first fixing member and the second fixing member;
a first adjusting member connected to an end of the shaft and abutting against the first fixing member;
a second adjusting member connected to the other end of the shaft, the second adjusting member cooperating with the first adjusting member for driving the second fixing member to move relative to the first fixing member along the shaft, so as to adjust a gap between the first fixing member and the second fixing member; and
a handle pivoted to the second fixing member and abutting against the second fixing member for pressing the second fixing member to approach the first fixing member, so as to force the clamping member to clamp the supporting tube.

2. The clamping mechanism of claim 1, wherein the handle comprises:
a pivotal portion eccentrically pivoted to the second adjusting member;
a pressing cam protruding from the pivotal portion; and
a handle portion connected to the pivotal portion for rotating the pivotal portion to drive the pressing cam to press the second fixing member.

3. The clamping mechanism of claim 2, wherein a pivotal hole is formed on the pivotal portion for being pivoted to the second adjusting member, the pivotal portion comprises a slot structure connected to a surface of the pressing cam and the pivotal hole, and the other end of the shaft is connected to the second adjusting member via the slot structure.

4. The clamping mechanism of claim 1, wherein the shaft comprises a thread portion, and the first adjusting member and the second adjusting member are respectively screwed to the end of the shaft and the other end of the shaft.

5. The clamping mechanism of claim 1, wherein the shaft and the first adjusting member are integrally formed.

6. The clamping mechanism of claim 1, wherein the shaft and the second adjusting member are integrally formed.

7. The clamping mechanism of claim 1, wherein the clamping member is a substantially rectangular clamping structure.

8. The clamping mechanism of claim 1, wherein the clamping member comprises a stopping structure for stopping an end of the supporting tube.

9. The clamping mechanism of claim 1, wherein the clamping member, the connecting portion, the first fixing member and the second fixing member are integrally formed.

10. The clamping mechanism of claim 1, wherein the connecting portion is riveted to the holder.

11. The clamping mechanism of claim 1, wherein the supporting tube is an antenna receiving holder.

12. An antenna device, comprising:
a holder;
a supporting tube for supporting the holder; and
a clamping mechanism for fixing the holder and the supporting tube, the clamping mechanism, comprising:
a clamping member for enclosing a supporting tube;
a connecting portion extending from the clamping member for being connected a holder;
a first fixing member connected to an edge of the clamping member;
a second fixing member connected to another edge of the clamping member;
a shaft disposed through the first fixing member and the second fixing member;
a first adjusting member connected to an end of the shaft and abutting against the first fixing member;
a second adjusting member connected to the other end of the shaft, the second adjusting member cooperating with the first adjusting member for driving the second fixing member to move relative to the first fixing member along the shaft, so as to adjust a gap between the first fixing member and the second fixing member; and
a handle pivoted to the second fixing member and abutting against the second fixing member for pressing the second fixing member to approach the first fixing member, so as to force the clamping member to clamp the supporting tube.

13. The antenna device of claim 12, wherein the handle comprises:
a pivotal portion eccentrically pivoted to the second adjusting member;
a pressing cam protruding from the pivotal portion; and
a handle portion connected to the pivotal portion for rotating the pivotal portion to drive the pressing cam to press the second fixing member.

14. The antenna device of claim 13, wherein a pivotal hole is formed on the pivotal portion for being pivoted to the second adjusting member, the pivotal portion comprises a slot structure connected to a surface of the pressing cam and the pivotal hole, and the other end of the shaft is connected to the second adjusting member via the slot structure.

15. The antenna device of claim 12, wherein the shaft comprises a thread portion, and the first adjusting member and the second adjusting member are respectively screwed to the end of the shaft and the other end of the shaft.

16. The antenna device of claim 12, wherein the shaft and the first adjusting member are integrally formed.

17. The antenna device of claim 12, wherein the shaft and the second adjusting member are integrally formed.

18. The antenna device of claim 12, wherein the clamping member is a substantially rectangular clamping structure.

19. The antenna device of claim 12, wherein the clamping member comprises a stopping structure for stopping an end of the supporting tube.

20. The antenna device of claim 12, wherein the connecting portion is riveted to the holder.
